(19) United States
(12) Patent Application Publication
(10) Pub. No.: US 2012/0097259 A1
(43) Pub. Date: Apr. 26, 2012

(54) Systems and Methods of Capping an Underwater Pipe

(76) Inventors: James Cabot Baltimore, Powder Springs, GA (US); Kenton Ridgeway Fleming, Marietta, GA (US)

(21) Appl. No.: 12/944,062

(22) Filed: Nov. 11, 2010

Related U.S. Application Data
(63) Continuation-in-part of application No. 12/911,565, filed on Oct. 25, 2010, now abandoned.

(51) Int. Cl. F15D 1/02; B23P 19/04

(52) U.S. Cl. 137/15.01; 29/282

(57) ABSTRACT

Disclosed herein in example embodiments is a quick fitting mechanism for stopping oil flow from a well head flange. Example embodiments of systems and methods of capping an underwater pipe disclosed herein may be used to fit a housing over an open pipe, the open pipe having a flange at the opening. In example embodiments of this system, the damaged pipe is cut at a location just above a flange in the pipe such that one or more latches in the housing are moved over and secured to the flange, securing the housing to the flange. Example embodiments include hydraulics to move a ram pipe through the housing to abut the opening of the pipe, thereby sealing the pipe when the hydraulics are engaged. A fastening means is also included to secure the ram seal down onto the housing thereby sealing off the pipe without the need for hydraulics or the like to remain engaged.

### PRIORITY CLAIM TO RELATED US APPLICATIONS

To the full extent permitted by law, the present United States Non-provisional patent application, is a Continuation-in-Part of, and hereby claims priority to and the full benefit of United States Non-provisional Application entitled “Systems and Methods of Capping an Underwater Pipe,” having assigned Ser. No. 12/911,565 filed on Oct. 25, 2010, incorporated herein by reference in its entirety.

### TECHNICAL FIELD

The present disclosure is generally related to piping and, more particularly, is related to capping pipes.

### BACKGROUND

Pipes located deep under the sea are used extensively for the transportation of oil, natural gas and other fluids. Subsea piping systems are highly susceptible to corrosion which damages the pipes and cause leaks. Additionally, pipes may burst due to poor construction and other forces acting upon such systems. If a pipe is damaged and breaks, then the oil, natural gas and other fluids may escape into the surrounding water. As a pipe may be under tremendous pressure from escaping oil, stopping the flow of the oil, natural gas or other fluids may be difficult. Difficulty in capping a pipe may be increased due to extreme depths at which some pipes are located. At these depths, diver intervention is not usually possible and the pipes may only be accessed using remote operable vehicles (ROVs). There is an enormous demand for a means for capping a damaged pipe deep under water that is quick and simple to install, and that can be installed with ease.

### SUMMARY

Example embodiments of the present disclosure provide systems and methods of capping an underwater pipe. Briefly described, in architecture, one example embodiment of the system among others can be implemented as follows: a housing; a sealing ram slidably positioned within the housing, the RAM configured to abut to an open pipe; a plurality of latches integrated into the housing, the latches configured to move over the flange on the pipe and into a locking position, securing the housing to the pipe; a locking mechanism configured to lock the latches in the locked position; a plurality of hydraulic actuators positioned within the housing, the actuators configured for sliding the RAM within the housing to seal the open pipe; and a securing mechanism configured to secure the RAM within the housing to seal the open pipe.

Embodiments of the present disclosure can also be viewed as providing methods for systems and methods of capping an underwater pipe. In this regard, one embodiment in such a method, among others, can be broadly summarized by the following: positioning the housing over an open pipe, the housing comprising integrated latches, the latches movable over a flange on the pipe and into a lockable position and a slidable RAM position through an opening in a top side of the housing; locking the latches in position over the flange on the pipe; and sliding the RAM within the housing to seal the opening in the pipe.

### BRIEF DESCRIPTION OF THE DRAWINGS

FIG. 1 is a cross-sectional view of an example embodiment of a system of capping an underwater pipe, latched on to a flange on the pipe.

FIG. 2 is an exploded view of an example embodiment of a drop ring, pillow block retainer, and bell housing of the system of FIG. 1.

FIG. 3 is an exploded view of an example embodiment of a latch in the housing of the system of FIG. 1.

FIG. 4 is an exploded view of an example embodiment of the hydraulics in the bell housing of the system of FIG. 1.

FIG. 5 is an exploded view of an example embodiment of the ram and housing of the system of FIG. 1.

FIG. 6A is a cross-sectional view of the system of FIG. 1 before attachment to the pipe.

FIG. 6B is a cross-sectional view of an example embodiment of the system of FIG. 1 as the system moves onto the pipe.

FIG. 6C is a cross-sectional view of an example embodiment of the system of FIG. 1 as the latches move over the flange.

FIG. 6D is a cross-sectional view of an example embodiment of the system of FIG. 1 with the latches moved over the flange and the ram secured into the housing.

FIG. 7 is a flow diagram of a method of capping an underwater pipe.

### DETAILED DESCRIPTION

Embodiments of the present disclosure will be described more fully hereinafter with reference to the accompanying drawings in which like numerals represent like elements throughout the several figures, and in which example embodiments are shared. Embodiments of the claims may, however, be embodied in many different forms and should not be construed to be limited to the embodiments set forth herein. The examples set forth herein are non-limiting examples, and are merely examples among other possible examples.

Crude oil and similar leaks can cause minor or massive damage to land or aquatic environments. Sometimes safety devices fail, as in the case of the British Petroleum (BP) Deepwater Horizon event that occurred in the Mississippi Canyon 252 site. A number of different attempts to stem the flow were attempted with varying degrees of success. As estimates of oil flow rates climbed steadily from 5,000 barrels per day up to a stunning 60,000 barrels per day, the efforts ramped up. A “top-kill” approach was used that involved injecting large amounts of mud and drilling fluid into the well to stem the flow. However, this was also unsuccessful.

The technical difficulties involved with an enormous leak under 5,000 feet of water are very difficult to overcome. Oil wells generally use blowout preventers, which are used to stop oil well gushers from happening. If the blowout preventers fail, though, as occurred in the Deepwater Horizon well, a solution to stem the flow of oil from the pipe must be employed.

Retrieving oil up from deep underground that is, in turn, deep underwater, is clearly, a complicated undertaking. Capping a pipe that is broken and retrieving the oil may be an even harder undertaking. This disclosure provides a solution to capping an underwater pipe. Disclosed herein in example embodiments is a quick fitting mechanism for stopping oil flow from a well head flange. Example embodiments of systems and methods of capping an underwater pipe disclosed herein may be used to fit a housing over an open pipe, the open pipe having a flange at the opening. In example embodiments of this system, the damaged pipe is cut at a location just above a flange in the pipe such that one or more latches in the housing are moved over and secured to the flange, securing the housing to the flange. Example embodiments include hydraulics to move a ram pipe and ram seal through the housing to abut the opening of the pipe, thereby sealing the pipe when the hydraulics are engaged. A fastening means is also included to secure the ram pipe and ram seal down onto the housing thereby sealing off the pipe.

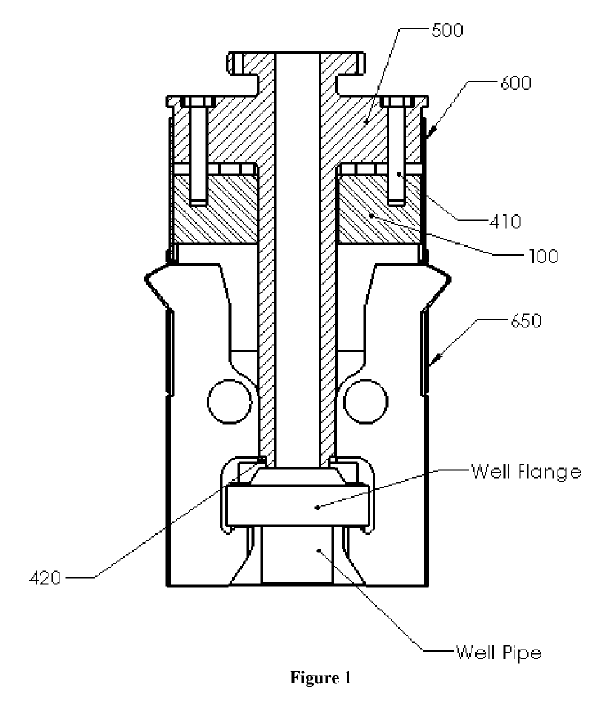

FIG. 1 provides a cross-sectional view of a system of capping an underwater pipe. The system of FIG. 1 includes bell housing 100, ram 500, retainer 600, disengager 650, bolts 410 and seal 420. The system includes a latching mechanism designed to grab hold of or securely attach to a well head flange. This example embodiment comprises a “slip fit” type of quick connect. In an example embodiment, the system is dropped over a flange in the pipe and the system of capping an underwater pipe automatically engages by means of gravitational forces. An example embodiment may be designed to contain oil pressure of 15,000 pounds per square inch, for example. Example embodiments may include no threaded fasteners holding it together, or electronics controlling it. The system fits over the well pipe with an opening just above a well flange or a pipe flange. In a preferred embodiment, the well pipe has an outside diameter of 22 inches and an inside diameter of 19 inches and the well head flange has an outside diameter of 43 and a thickness of 12 inches; however, other dimensions are contemplated herein. In operation, bell housing 100 is dropped over a flange at an open end of the pipe. The pipe may need to be cut just above the flange. The latches slide over the flange and lock into place. Ram 500 is then pulled down onto the open end of the pipe so that seal 420 mates with the pipe, sealing the oil flow creating a two pipe sealed connection.

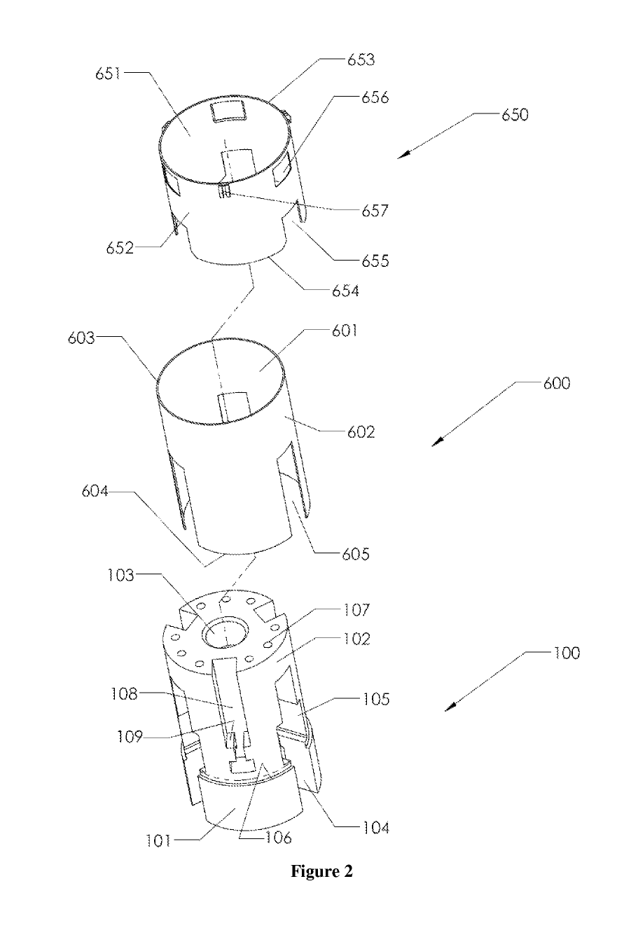

FIG. 2 provides an example embodiment of bell housing 100 with pillow block retainer 600 and drop ring 650. Bell housing 100 has outer diameter 101 with an outer diameter surface 102 that is slightly smaller such that pillow block retainer 600 fits along the surface of outer diameter 102 and on top of the ledge formed by outer diameter 101. In a preferred embodiment, bell housing 100 has an outside diameter of approximately 79 inches, is preferably formed of a suitable material, such as chrome moly, dual phase steel or the like having approximately 100 KSI yield (1000 psi (pounds-per-square inch) is abbreviated KSI), and is preferably manufactured by machining, forging or the like and is coated with an anti-corrosion treatment. Opening 103 in bell housing 100 is configured to receive the ram for sealing the pipe. In a preferred embodiment, opening 103 has an inside diameter of approximately 24 inches. Channel 104 is configured to receive the latch, the latch configured to fit over the pipe flange securing the housing to the pipe. In a preferred embodiment, channel 104 has approximately a length of 17.25 inches and a width of 103 inches. Channel 105 is configured to receive pillow blocks which hold the latch in the housing. In a preferred embodiment, channel 105 has approximately a length of 5 inches, a width of 24 inches, and height of 30.6 inches. Drop ring 600 then fits over the housing to retain the pillow blocks within the housing. Opening 605 is the same width as channel 104 such that pillow blocks cannot be removed from channel 105 when pillow block retainer 600 is in place over bell housing 100.

Shoulder 106 constitutes a difference in diameter from outer diameter 102 and outer diameter 101. Pillow block retainer 600 slides along the surface of outer diameter 102 and rests on shoulder 106. An example embodiment of bell housing 100 may be configured with a plurality of holes 107 tapped in the top section. Holes 107 may be configured to receive clamp bolts to clamp ram 500 to bell housing 100 after the hydraulics have positioned ram 500 onto the open pipe, sealing the pipe. In an example embodiment, recess 108 is configured to receive hydraulic components that may be used to pull bell housing 100 down onto the pipe. In a preferred embodiment, channel 108 has approximately a length of 14 inches, a width of 14 inches, and height of 80 inches. In an example embodiment, clevis 109 is configured to hold the bottom of a hydraulic lever.

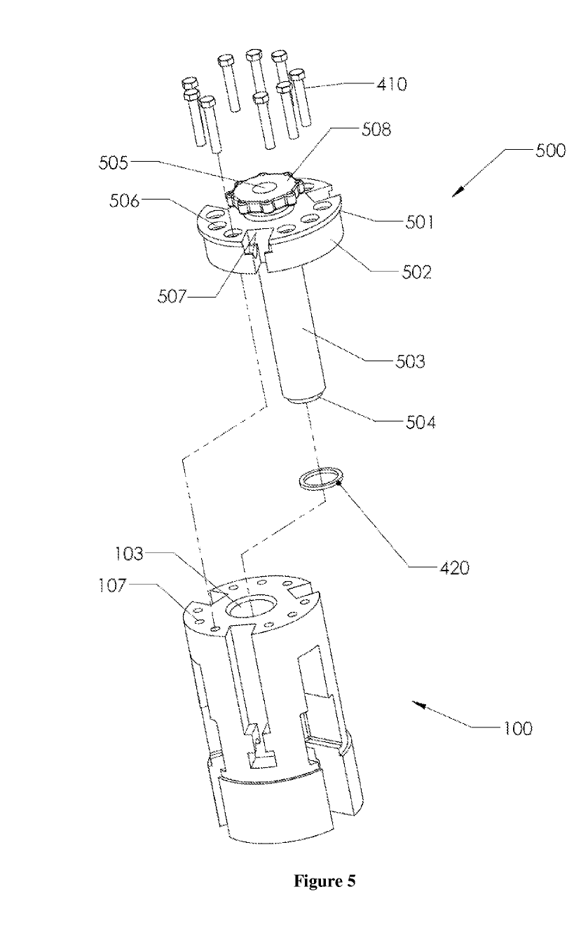

In an example embodiment, pillow block retainer 600 includes inner diameter surface 601 and outer diameter surface 602. In a preferred embodiment, block retainer 600 has approximately an inside diameter of approximately 75 inches and an outside diameter of approximately 77 inches, is preferably formed of a suitable material, such as carbon steel or the like having approximately 60 KSI yield, and is preferably manufactured by machining, forging, rolling or the like and is coated with an anti-corrosion treatment. Bottom edge 604 engages with shoulder 106 of bell housing 100. Opening 605 at the bottom of pillow block retainer 600 is configured to allow the latches to move in and out of bell housing 100, while retaining the pillow block bearings 150 within bell housing 100. In a preferred embodiment, opening 605 has approximately a length of 17.5 inches and a width of 62 inches. Pillow block retainer 600 holds pillow block bearing 150 and latches 200 in place, and may also provide a cylindrical surface 602 on which drop ring 650 slides. Top edge 603, in an example embodiment, is configured to engage retainer shoulder 501 of ram 500 from FIG. 5.

Drop ring 650 is configured with inner diameter surface 651 and outer diameter surface 652. In a preferred embodiment, drop ring 650 has approximately an inside diameter of approximately 77 inches and an outside diameter of approximately 79 inches, is preferably formed of a suitable material, such as carbon steel or the like having approximately 60 KSI yield, and is preferably manufactured by machining, forging, rolling or the like and is coated with an anti-corrosion treatment. The inner diameter surface 651 is configured to slide over outer diameter 602 of drop ring 600. The bottom edge 654 of drop ring 650 engages with shoulder 106 of Bell Housing 100. Top edge 653 of drop ring 650 is configured to engage with retainer shoulder 501 of ram 500 from FIG. 5. Latch guide 655 is configured to fit over the bottom portion of a latch seated in channel 104 and cam slot 656 secures the top extruding portion of the latch to lock it in place. In a preferred embodiment, latch guide 655 has approximately a length of 22 inches and a width of 18 inches. In a preferred embodiment, cam slot 656 has approximately a length of 14 inches and a width of 18 inches. Lifting lug 657 may be used to position the drop ring 650 into and out of position.

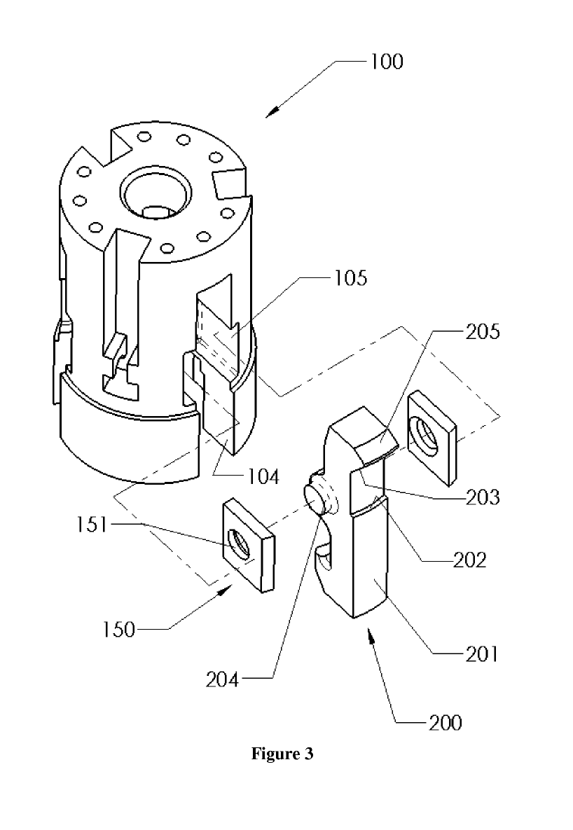

FIG. 3 provides an exploded view of an example embodiment of bell housing 100 with latch 200. Each detail of the geometry of latch 200 may serve a purpose for one or more of stress relief, balance, motion, clearance, and load capacity, among others. In a preferred embodiment, latch 200 is configured to rotatably fit within channel 104, is preferably formed of a suitable material, such as chrome moly, dual phase steel or the like having approximately 100 KSI yield, and is preferably manufactured by machining, forging or the like and is coated with an anti-corrosion treatment. In an example embodiment, latch 200 may be actuated by gravity, though, in alternative embodiments, latch 200 may be actuated with springs, hydraulics, electrical/electromechanical switches, etc. Latch 200 may be configured with outer diameter surface 201, and recess 202 for drop ring 650, disengaging cam surface 203, pivots 204 on both sides of latch 200, and circular cam surface 205, which is used to release drop ring 650. In a preferred embodiment, pivots 204 have approximately an outside diameter of approximately 13 inches.

In an example embodiment, latch 200 may be inserted into opening 104 in bell housing 100 with pillow block bearings 150 on either side. In a preferred embodiment, pillow block bearings 150 is configured to slide in to channel 105 having an inside diameter of approximately 13 inches, is preferably formed of a suitable material, such as chrome moly, dual phase steel or the like having approximately 100 KSI yield, and is preferably manufactured by machining, forging or the like and is coated with an anti-corrosion treatment. Openings 151 in pillow block bearing 150 are configured to receive pivots 204 on either side of latch 200. In an example embodiment, latch 200 with attached pillow block bearings 150 on either side may be positioned into channel 104 with pillow block bearings 150 fitting into channels 105 on either side of latch 200. The outer surface of pillow block bearings 150 may conform to the cylindricity of bell housing 100. Latch 200 may freely rotate along the axis passing through the center of pivots 204 on either side of latch 200.

Drop ring 650 may provide the locking of latches 200 in a “grabbed” position around the flange in the pipe. As latch 200 opens around the flange, cam surface 203 recedes inward, allowing drop ring 650 to drop. As the lower part of latch 200 clears below the flange surface, cam surface 203 swings inward, allowing drop ring 650 to further advance downward into a locked position. Lowering or raising drop ring 650 may occur through external lifting devices, powered components, etc. Reversing the motion of drop ring 650 upward allows latches 200 to be released from the flange.

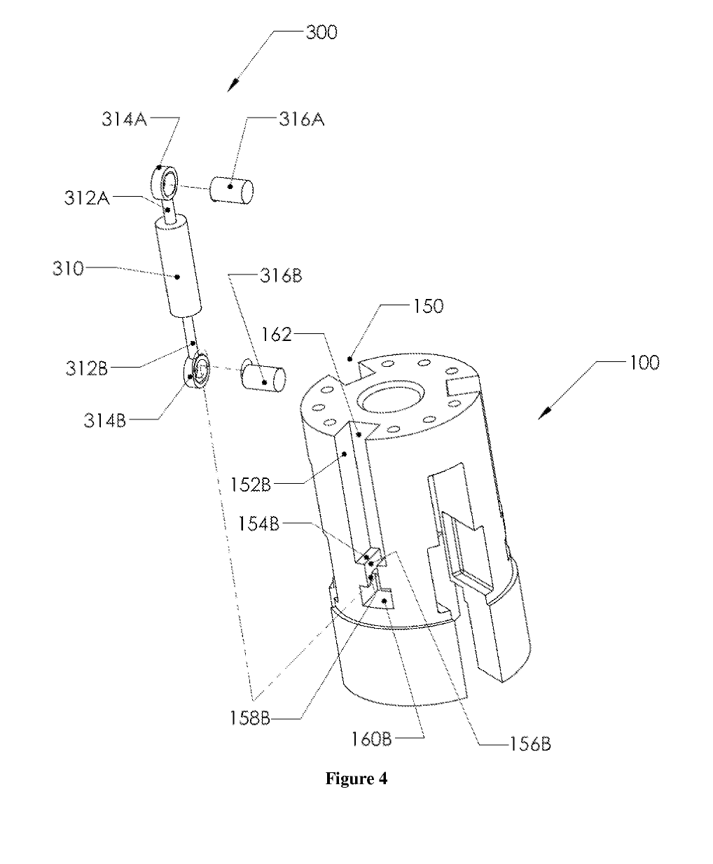

FIG. 4 provides an exploded view of an example embodiment of bell housing 100 with hydraulic device 300. Hydraulic device 300 includes body 310, extenders 312A and 312B, rings 314A and 314B, and dowels 316A and 316B. In a preferred embodiment, hydraulic device 300 is configured to slide in to one or more slots 150 and 507, and preferably be capable of providing approximately 300,000 to 1,000,000 lbs max of force. Bell housing 100 may include one or more slots 150 in which one or more hydraulic device 300 is fitted. In an example embodiment, slot 150 may include inner-surface 162, sidewall 152B, bottom lip 154B, inner-sidewall 156B, bottom 160B and bottom lip 158B. Dowel 3168 fits through ring 3148 and fits within the cutout formed by 1588 and 1608. Extender 312B fits in between surfaces 1568 on either side and body 310 fits within sidewall 152B, inner-surface 162 and bottom lip 154B. Dowel 316A fits within ring 314A. Hydraulic device 300 is used to pull ram 500 through the bell housing and down onto the open end of the pipe to seal the pipe, sealing the oil flow.

FIG. 5 provides an exploded drawing of an example embodiment of ram 500 and its components as ram 500 fits within opening 103 of bell housing 100. In a preferred embodiment, ram 500 is configured to slide in opening 103, is preferably formed of a suitable material, such as chrome moly, dual phase steel or the like having approximately 100 KSI yield, and is preferably manufactured by machining, forging or the like and is coated with an anti-corrosion treatment. An example embodiment of ram 500 includes retainer shoulder 501, having an approximate outside diameter of 78 inches, which pillow block retainer 600 and drop ring 650 mate against, outside diameter surface 502, having an approximate outside diameter of 75 inches, ram pipe 503, having an approximate outside diameter of 24 inches and seal shoulder 504, having an approximate outside diameter of 19 inches. Ram seal 420 mates with seal shoulder 504 to seal the top of the open pipe. Ram pipe 503 fits within ram opening 103 in bell housing 100. Ram pipe 503 is slidable through opening 103. A plurality of holes 506 are bored in the top of ram 500. In an example embodiment a plurality of holes 506 may accept clamping bolts 410, which fit into bell housing 100 through holes 107. Bolts 410 may be used to clamp ram 500 to bell housing 100. Upper clevis 507 may be used with hydraulic 300 to receive dowel 316A and ring 314A such that hydraulic 310 may be used to pull ram 500 through opening 103 down onto the open pipe. Ram 500 may then be clamped to the top of bell housing 100 with clamping bolts 410. Mounting base 508 may be used in an example embodiment to mount to an additional pipe. Drilling hole 505 may be drilled into the top of mounting base 508 to allow oil from the pipe to flow.

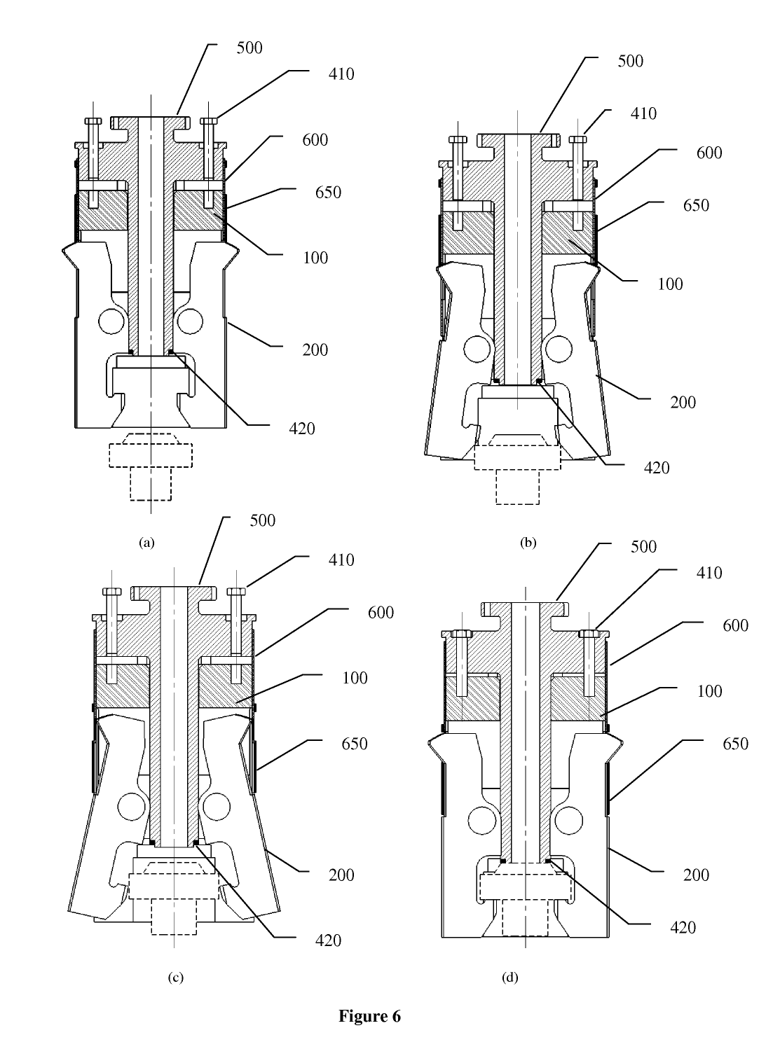

FIG. 6 provides cross-sectional views of the systems and methods of capping an underwater pipe, as it is moved onto a pipe flange with the latches moving out over the flange and then around the flange securing bell housing 100 to the open pipe. This is shown through four (4) figures: FIGS. 6A, 6B, 6C, and 6D. The cross-sectional view provides bell housing 100, ram 500, pillow block retainer 600, drop ring 650, latch 200, ram seal 420 and a plurality of bolts 410 to secure ram 500 to bell housing 100. FIG. 6A provides an example embodiment of a system of capping an underwater pipe as the system is preparing to be moved onto the pipe. FIG. 6B provides an example embodiment of the system as it is moved onto the pipe. As the system is moved onto the pipe, the bottom of latches 200 move outward to engage the flange. FIG. 6C provides an example embodiment of the system with latches 200 moving along the flange of the pipe.

FIG. 6D provides an example embodiment of the system with latches 200 secured around the flange in the pipe. The RAM 500 has been moved down such that seal 420 at the bottom of RAM 500 mates with the open pipe therein sealing the open pipe. A plurality of bolts 410 are tightened to secure RAM 500 to housing 100.

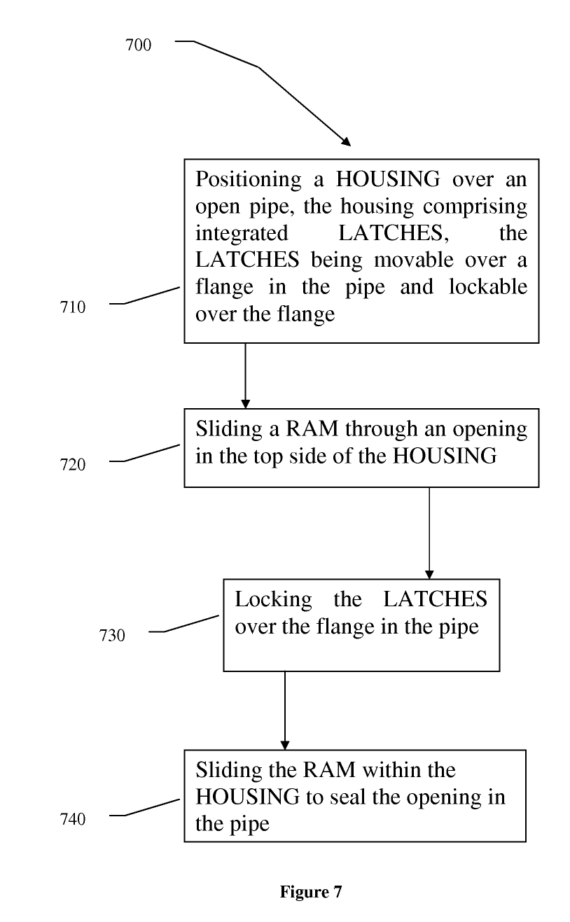

FIG. 7 provides flow diagram 700 of a method of capping an open pipe. In block 710, a housing comprising integrated latches is positioned over an open pipe wherein the latches in the housing are movable over a flange on the pipe and into a lockable position. In block 720, a sliding ram is positioned through an opening of the top side of the housing. In block 730, the latches are locked in position over the flange of the pipe. In block 740, the ram is slidably moved within the housing to seal the opening in the pipe.

Referring now to FIGS. 1-7, by way of example, and not limitation, there is illustrated a system of capping an underwater pipe, specifically, the well pipe has an outside diameter of 22 inches and an inside diameter of 19 inches and the well head flange has an outside diameter of 43 and a thickness of 12 inches, and it is recognized that alternative well pipe and well head flange sizes are available resulting in varied dimensions, materials, and manufacturing techniques for the configuration of a system of capping an underwater pipe to mate to such well pipe and well head flange configurations and such varied dimensions, materials, and manufacturing techniques are understood by one skilled in the art and are contemplated herein. Preferably, the dimensions, materials, and manufacturing techniques herein include other suitable characteristics, such as strength, durability, water-resistance, light weight, temperature-resistance, chemical inertness, oxidation resistance, ease of workability, or other beneficial characteristic understood by one skilled in the art. The foregoing description and drawings comprise illustrative embodiments. Having thus described exemplary embodiments, it should be noted by those skilled in the art that the disclosures within are exemplary only, and that various other alternatives, adaptations, dimensions, materials, and modifications may be made within the scope of the present disclosure. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

Therefore, at least the following is claimed:

1. A pipe capping system comprising:
a housing;
a sealing ram slidably positioned within the housing, the ram configured to abut an open pipe;
a plurality of latches integrated into the housing, the latches configured to move over the flange on the pipe and into a locking position, securing the housing to the pipe;
a locking mechanism configured to lock the latches in the locking position;
a plurality of hydraulic actuators positioned within the housing, the actuators configured for sliding the ram within the housing to seal the open pipe; and
a securing mechanism configured to secure the ram within the housing to seal the open pipe.

2. The pipe cutoff system of claim 1, wherein the housing comprises:
a top side with a center opening through which the ram engages a plurality around the perimeter of the center opening, the plurality of openings through which the securing mechanism secures the ram within the housing, and a plurality of slots configured for the plurality of hydraulic actuators; and
a bottom side with a plurality of slots configured for the plurality of latches.

3. The pipe cutoff system of claim 1, wherein the sealing ram is configured to slide through an opening in a top side of the housing and a plurality of openings through which the sealing ram is secured to the housing with the securing mechanism, the ram further configured to seat to the opening in the pipe, sealing the opening.

4. The pipe cutoff system of claim 1, wherein the plurality of latches are actuated by at least one of gravity, springs, hydraulics, and electrical/electromechanical force.

5. The pipe cutoff system of claim 1, wherein the locking mechanism comprises a shell configured to slide along the housing and to prevent the latches from releasing when the shell is in a locking position.

6. The pipe cutoff system of claim 1, wherein the locking mechanism comprises a drop ring, the drop ring fitting around the perimeter of the housing, the drop ring comprising a plurality of openings, each opening configured to engage at least one of the plurality of latches, preventing the at least one of the plurality of latches from disengaging.

7. The pipe cutoff system of claim 1, further comprising a plurality of pillow blocks configured to removably fit within the housing and on a first and second side of at least one of the plurality of latches to enable the pendulation of the latch.

8. The pipe cutoff system of claim 7, further comprising a retainer sleeve configured to fit around a perimeter of the housing and within the perimeter of a drop ring, the drop ring fitting around the perimeter of the housing, the retainer sleeve further configured to hold the plurality of pillow blocks and the plurality of latches in place in the housing.

9. A method of capping a pipe comprising:
positioning a housing over an open pipe, the housing comprising:
integrated latches, the latches movable over a flange on the pipe and into a lockable position; and
a slidable ram positioned through an opening in a top side of the housing;
locking the latches in position over the flange on the pipe; and
sliding the ram within the housing to seal the opening in the pipe.

10. The method of capping a pipe of claim 9, further comprising securing the ram within the housing with locking bolts.

11. The method of capping a pipe of claim 9, wherein sliding the ram within the housing comprises sliding the ram by means of at least one of hydraulics, pneumatics, springs, and electrical/electromechanical force.

12. The method of capping a pipe of claim 9, wherein locking the latches in position over the flange on the pipe comprises sliding a locking ring over at least one end of the latches to prevent the latches from disengaging.

13. A system of capping a pipe comprising:
means for positioning a housing over an open pipe, the housing comprising:
integrated latching means, the latching means movable over a flange on the pipe and into a lockable position; and
a sealing means positioned through an opening in a top side of the housing;
means for locking the latching means in position over the flange on the pipe; and
means for sliding the sealing means within the housing to seal the opening in the pipe.

14. The system of capping a pipe of claim 13, further comprising means for securing the sealing means within the housing.

15. The system of capping a pipe of claim 14, wherein the means for securing is at least one locking bolt.

16. The system of capping a pipe of claim 13, wherein the means for sliding the sealing means within the housing comprises at least one of hydraulics, springs, and electrical/electromechanical force.

17. The system of capping a pipe of claim 13, wherein the means for locking the latches in position over the flange on the pipe comprises means for locking at least one end of at least one the latching means to prevent the at least one latching means from disengaging.
